(19) United States
(12) Patent Application Publication
(10) Pub. No.: US 2017/0167897 A1
(43) Pub. Date: Jun. 15, 2017

(54) ANGLE MEASUREMENT DEVICE AND ELECTRIC MOTOR

(71) Applicant: Rheintacho Messtechnik GmbH, Freiburg (DE)

(72) Inventors: Elmar Lackermaier, Merzhausen (DE); Frank Henninger, Freiburg (DE)

(73) Assignee: Rheintacho Messtechnik GmbH, Freiburg (DE)

(21) Appl. No.: 15/372,856

(22) Filed: Dec. 8, 2016

(30) Foreign Application Priority Data
Dec. 9, 2015 (DE) 202015008430.3

(51) Int. Cl. G01D 5/244; H02K 11/215; G01D 5/20; G01D 5/14; G01D 5/165

(52) U.S. Cl. CPC G01D 5/24428; G01D 5/142; G01D 5/165; G01D 5/2006; H02K 11/215

(57) ABSTRACT

An angle measurement device for an electric motor, including an angle disk which is mountable in a rotationally fixed manner to a shaft. Two measurement tracks are formed on the angle disk having differing angular resolutions with respect to a rotational movement of the angle disk. A sensor device is provided with which the two measurement tracks are readable in order to generate at least one angle-dependent signal for each of the measurement tracks of the two measurement tracks. The angle disk has, at least in a region of the measurement tracks, a magnetically conductive material which defines the respective angular resolution by way of a respective configuration, and the sensor device has at least one biased magnetic field sensor.

### INCORPORATION BY REFERENCE

The following documents are incorporated herein by reference as if fully set forth: DE 20 2015 008 430.3, filed Dec. 9, 2015.

### BACKGROUND

The invention relates to an angle measurement device, in particular for an electric motor, having an angle disk which is mountable in a rotationally fixed manner to a shaft, wherein two measurement tracks with differing angular resolutions with respect to a rotational movement of the angle disk are formed on the angle disk, and having a sensor device with which the two measurement tracks are readable in order to generate at least one angle-dependent signal for each measurement track of the two measurement tracks.

The invention furthermore relates to an electric motor having a rotor shaft which is mounted in a motor housing, wherein an angle disk of an angle measurement device is arranged on the rotor shaft.

It is known to capture and monitor the angular position of a rotor shaft using an angle measurement device. To this end it has become customary to form an incremental measurement track with relatively high angular resolution. This is frequently done via a perforated disk which interacts with an optical sensor. It is likewise known to form the incremental measurement track from a permanent magnetic material which is magnetized in an alternating fashion. In order to capture one complete revolution, the incremental measurement track frequently has an associated synchronization measurement track which can be formed by a magnetic dipole which is aligned transversely to the rotational axis or by a single hole, the passage of which is optically captured.

### SUMMARY

The invention is based on the object of finding an alternative way for measuring angles in an electric motor.

In order to achieve this object in an angle measurement device of the type described in the introduction, the invention provides in particular that the angle disk have, at least in the region of the measurement tracks, a magnetically conductive material which defines the respective angular resolution by way of a respective configuration, and that the sensor device has at least one biased magnetic field sensor. The use of biased magnetic field sensors, which can be characterized by the presence of an artificially generated magnetic field whose change is capturable with the magnetic field sensor, allows for magnetized measurement tracks to be dispensed with. This significantly simplifies manufacturing. The use of magnetic field sensors allows for optical measurement methods to be dispensed with. The angle measurement device is thus robust and may be configured with small space requirement.

The shaft which carries the angle disk can here be, for example, the rotor shaft of an electric motor, a driven shaft of a motor (for example an electric motor or an internal combustion engine), or a shaft of a transmission. Generally, the invention may be advantageously used for capturing a rotational movement of a rotating part which is formed by the shaft or coupled to the shaft.

In one embodiment of the invention, provision may be made for the respective angular resolution to be defined by an angle-dependent distance of the magnetically conductive material from the sensor device. An easily producible measurement track on an angle disk is thus described here, wherein the angle-dependent distance may be formed, for example, in a casting process for the angle disk or by later material removal.

Alternatively or additionally, provision may be made for the respective angular resolution to be defined by an angle-dependent material strength and/or shape of the magnetically conductive material. The measurement tracks may thus be formed directly in one casting process for the angle disk. Later processing of the measurement tracks may be dispensed with.

In one embodiment of the invention, provision may be made for a separately biased magnetic field sensor to be assigned to each measurement track of the two measurement tracks. The measurement tracks are thus separately readable. This allows a spaced-apart arrangement of the measurement tracks.

In one embodiment of the invention, provision may be made for the measurement track having a higher angular resolution to have two sub-tracks with matching angular resolution which are offset with respect to one another in the direction of the rotational movement of the angle disk. The advantage here is that a sense of direction of the rotational movement is capturable, for example by way of an offset which is selected to be smaller than the angular resolution given by the measurement track. An AB track may be formed on the angle disk in this way.

Alternatively or additionally, provision may be made for two magnetic field sensors which are offset with respect to one another in the direction of the rotational movement of the angle disk to be assigned to the measurement track having a higher angular resolution. If this offset of the magnetic field sensors is selected appropriately, for example to be smaller than the angular resolution, it is possible to ascertain a sense of direction of the rotational movement by way of comparing the output signals of the two magnetic field sensors which read the measurement track.

In one embodiment of the invention, provision may be made for the measurement track having a lower angular resolution to be configured such that it is arranged radially within the measurement track having a higher angular resolution. As a consequence, there is sufficient space for creating the higher angular resolution, since a great circumferential length is available for this measurement track.

In one embodiment of the invention, provision may be made for the measurement track having a lower angular resolution to be formed by modulating the measurement track having the higher angular resolution. The space taken up by the two measurement tracks may thus be reduced. The measurement tracks which are linked by way of the modulation are readable with a common magnetic field sensor.

In one embodiment of the invention, provision may be made for the measurement track having a lower angular resolution to have an angular resolution of more than 180°. This may be achieved, for example, by way of a single marking along the measurement track. It is thus possible to form a synchronization measurement track in a simple manner.

In one embodiment of the invention, provision may be made for the angle disk to be in the form of a gear wheel, wherein the measurement track having the higher angular resolution is defined by teeth of the gear wheel. An incremental measurement track may thus be formed in a simple manner. This can already take place in the casting process of the angle disk. Later machining of the teeth is not necessary since no transfer of force by the teeth is necessary and/or intended.

In one embodiment of the invention, provision may be made for the measurement track having the lower angular resolution to be defined by a delimited material cutout or material thickening in the angle disk. The invention utilizes the fact here that manufacturing methods having high manufacturing tolerances suffice to achieve the low angular resolution.

In one embodiment of the invention, provision may be made for the magnetic field sensor to be a Hall effect sensor, an oscillating sensor, an inductive magnetic field sensor, in particular an oscillating sensor, or an MR sensor, for example a TMR sensor, an AMR sensor or a giant magnetoresistance sensor. A change in a magnetic field generated by the bias is thus capturable particularly well as the measurement tracks pass through.

In one embodiment of the invention, provision may be made for the bias to be generated by means of a permanent magnet. As a consequence, no energy supply is necessary for achieving the bias.

In one embodiment of the invention, provision may be made for the angle disk to be made of a ferromagnetic material. The advantage here is that manufacturing the measurement tracks from a separate material may be dispensed with. The angle disk may thus be produced from a single, homogeneous material.

In one embodiment of the invention, provision may be made for the angle disk to be made in the form of a cast part. Cost-effective manufacturing is thus attainable.

In one embodiment of the invention, provision may be made for the measurement track having the higher angular resolution to be readable with a radially oriented magnetic field sensor. To this end, the measurement track can be formed along an edge of the angle disk. The advantage here is that a measurement track having a maximum circumference may be used for the higher angular resolution.

In one embodiment of the invention, provision may be made for the measurement track having the lower angular resolution to be readable with an axially oriented magnetic field sensor. To this end, the measurement track can be formed on a side face of the angle disk.

In order to achieve the stated object, the one or more features directed to an electric motor are provided according to the invention. In particular, it is thus provided for achieving the stated object according to the invention in an electric motor of the type described in the introduction that the angle measurement device be formed according to the invention, in particular as described above and/or as claimed in one of the claims which are directed to an angle measurement device.

In one embodiment of the invention, provision may be made for the angle measurement device to be arranged in the winding space.

Alternatively or additionally, provision may be made for the angle measurement device to be arranged axially between a bearing shield and a motor winding.

### BRIEF DESCRIPTION OF THE DRAWINGS

The invention will now be explained in more detail with reference to exemplary embodiments, without however being limited to said exemplary embodiments. Further exemplary embodiments result from a combination of the features of individual or a plurality of claims with one another and/or with individual features or a plurality of features of the exemplary embodiments.

In the figures:

FIG. 1 shows an angle measurement device according to the invention,

FIG. 2 shows a further angle measurement device according to the invention,

FIG. 3 shows a third angle measurement device according to the invention, and

FIG. 4 shows a fourth angle measurement device according to the invention.

### DETAILED DESCRIPTION OF THE PREFERRED EMBODIMENTS

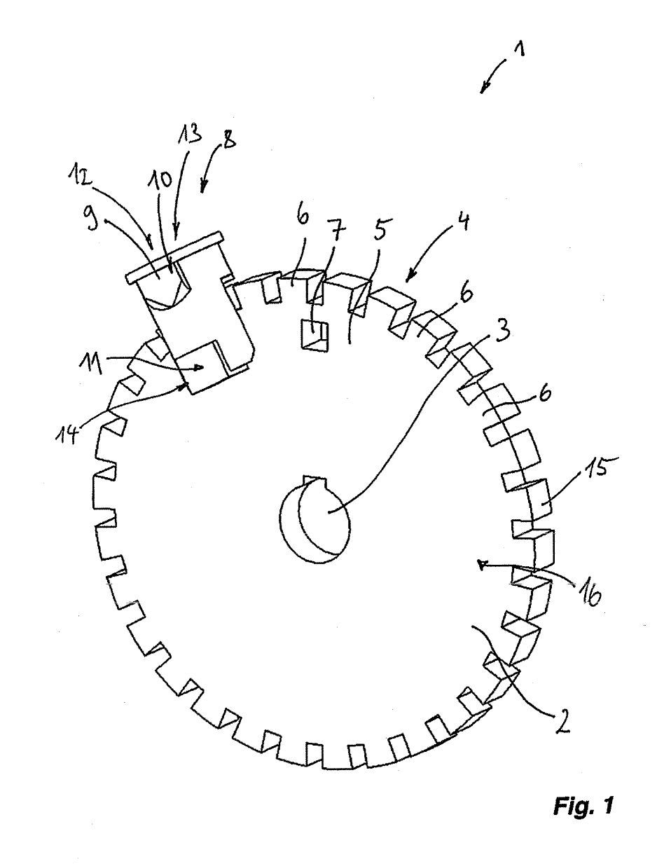

FIG. 1 shows an angle measurement device which is designated overall with 1. The angle measurement device 1 has an angle disk 2 which is mountable in a rotationally fixed manner via a central opening 3 on a rotor shaft (not illustrated further) of an electric motor or on a shaft that is otherwise driven—for example using a feather key.

Two measurement tracks 4, 5 are formed on the angle disk 2. The measurement track 4 is here defined by a sequence of teeth 6, wherein the angular resolution of the measurement track 4 is given by the angle distance of neighboring teeth 6. The measurement track 5 is defined by way of the material cutout 7, as a result of which an angular resolution of 360° is produced. The material cutout 7 is here limited to a narrow angular range. The angular resolution of the measurement track 5 is therefore significantly less precise and larger than the angular resolution of the measurement track 4. The measurement track 4 thus forms an incremental measurement track, while the measurement track 5 forms a synchronization measurement track which merely indicates full revolutions.

The angle measurement device 1 furthermore has a sensor device 8 with which the two measurement tracks 4, 5 are readable. The sensor device 8 is adapted such that at least one angle-dependent signal is generated for each measurement track 4, 5 when the angle disk 2 moves past the sensor device 8 as part of its rotational movement.

The angle disk 2 is made of magnetically conductive material at least in the region of the measurement tracks 4, 5. The magnetically conductive material has the characteristic of changing the profile of magnetic field lines by way of its presence without necessarily being permanent magnetic itself. By way of example, the magnetically conductive material is a ferromagnetic, ferrimagnetic or diamagnetic material.

The sensor device 8 has magnetic field sensors 9, 10, 11, wherein the magnetic field sensors 9 and 10 are assigned spatially and functionally to the measurement track 4, and the magnetic field sensor 11 is assigned spatially and functionally to the measurement track 5.

The magnetic field sensors 9, 10, 11 are biased in each case by means of a permanent magnet 12, 13, 14 (“back biased”). Each of the permanent magnets 12, 13, 14 generates magnetic field lines which penetrate the associated magnetic field sensor 9, 10, 11, with the profile thereof being influenced by the magnetically conductive measurement track 4, 5. The change in field lines as the respective measurement track 4, 5 passes through past the associated magnetic field sensor 9, 10, 11 is thus detectable and results in a respective angle-dependent signal, which may be used for angle measurement.

The magnetic field sensors 9, 10, 11 are here in each case arranged between the associated permanent magnets 12, 13, 14 and the associated measurement track 4, 5.

The permanent magnets 12, 13, 14 can also be aggregated entirely or partially into one or two permanent magnets.

By way of making the (first) measurement track 4 a sequence of teeth 6 with gaps inbetween, an angle-dependent distance of the magnetically conductive material from the magnetic field sensor 9 or 10 is obtained, as a result of which the magnetic field lines of the bias are deformed in the described manner when the angle disk rotates.

Due to the material cutout 7, an angle-dependent material strength of the magnetically conductive material comes about in the (second) measurement track 5. This in turn leads to an angle-dependent signal of the magnetic field sensor 11.

The two magnetic field sensors 9, 10, which are assigned to the measurement track 4, are arranged such that they are offset with respect to one another in the direction of the rotational movement, i.e. longitudinally with respect to the measurement track 4. What is achieved hereby is that the signal of the magnetic field sensor 9 is generated with a time offset with respect to the signal of the magnetic field sensor 10, although both signals correlate to the measurement track 4.

With a suitable offset of the magnetic field sensors 9, 10, an AB track may thus be formed.

The measurement track 4 is formed along the edge 15 of the angle disk 2, while the measurement track 5 is arranged on a side face 16 and thus radially within the measurement track 4.

As can also be seen in FIG. 1, this allows for the measurement track 4 to be readable with radially oriented magnetic field sensors 9, 10, and by contrast for the measurement track 5 to be readable with the axially (with respect to the rotational movement of the angle disk 2) oriented magnetic field sensor 11.

In the exemplary embodiment, the magnetic field sensors 9, 10, 11 are in each case implemented in the form of a Hall effect sensor, an oscillating sensor, an inductive magnetic field sensor, in particular in the form of an oscillating sensor, or a magnetoresistive sensor (MR sensor), for example a TMR sensor based on the tunnel magnetoresistance, TMR), an AMR sensor based on the anisotropic magnetoresistive effect (AMR effect) or a giant magnetoresistance (GMR) sensor.

The angle disk 2 is manufactured in the form of a cast part from a ferromagnetic material, as a result of which the magnetic conductivity of the measurement tracks 4, 5 according to the invention is produced.

During use, the angle disk 2 is arranged on a rotor shaft of an electric motor and placed together with the sensor device inside the motor housing axially between the bearing shields on one side of the motor winding, preferably on the B side.

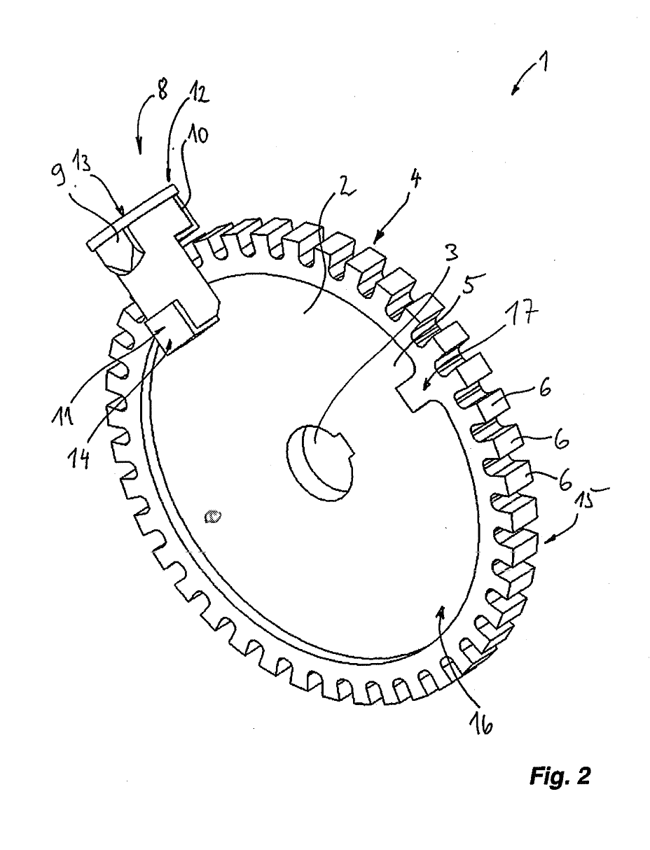

FIGS. 2 to 4 show further exemplary embodiments of angle measurement devices 1 according to the invention. Components and functional units which are similar or identical in terms of function and/or construction to the exemplary embodiment according to FIG. 1 are designated with the same reference signs and not described separately. The statements made regarding FIG. 1 correspondingly apply to FIGS. 2 to 4.

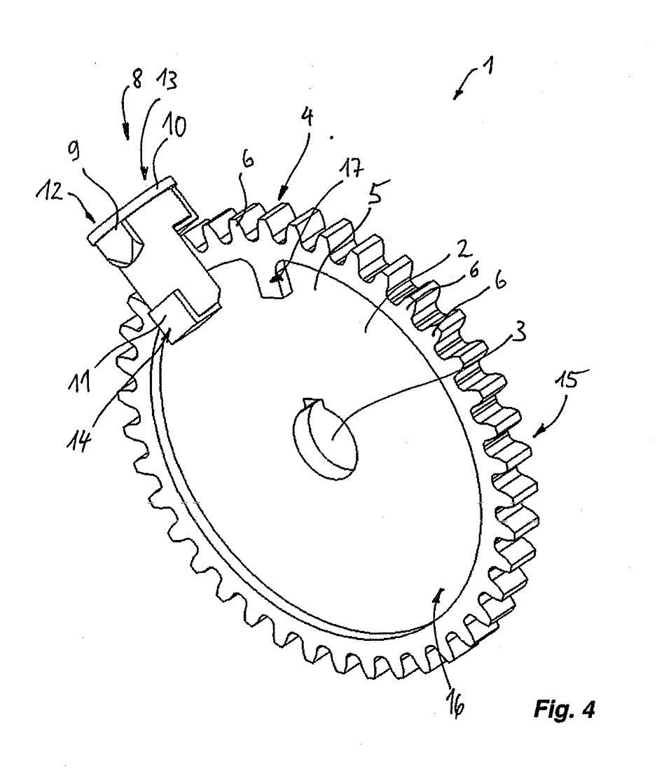

In the exemplary embodiments according to FIG. 2 and FIG. 4, a material thickening 17 is formed instead of the material cutout 7 to define the measurement track 5.

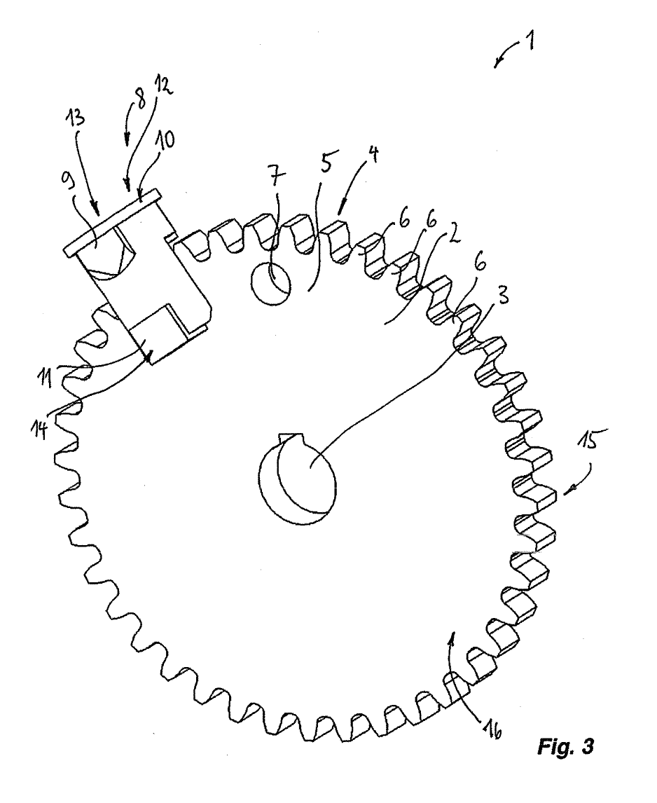

In the exemplary embodiments according to FIG. 3 and FIG. 4, the teeth 6 are configured with reliefs at the tips, such that the angle disk 2 is also usable as a gear wheel.

Provisions are thus made in an angle measurement device 1 for two measurement tracks 4, 5 to be formed with magnetically conductive material, wherein the respective angular resolutions differ, and for in each case at least one magnetically biased magnetic field sensor 9, 10, 11 to be assigned to the measurement tracks 4, 5.

### LIST OF REFERENCE SIGNS

1 angle measurement device
2 angle disk
3 central opening
4 measurement track
5 measurement track
6 tooth
7 material cutout
8 sensor device
9 magnetic field sensor
10 magnetic field sensor
11 magnetic field sensor
12 permanent magnet
13 permanent magnet
14 permanent magnet
15 edge
16 side face
17 material thickening

1. An angle measurement device (1) for an electric motor, comprising an angle disk (2) which is mountable in a rotationally fixed manner to a shaft, two measurement tracks (4, 5) formed on the angle disk (2), the two measurement tracks (4,5) having differing angular resolutions with respect to a rotational movement of the angle disk (2), a sensor device (8) with which the two measurement tracks (4, 5) are readable in order to generate at least one angle-dependent signal for each of the measurement tracks (4, 5) of the two measurement tracks (4, 5), the angle disk (2) has, at least in a region of the measurement tracks (4, 5), a magnetically conductive material which defines the respective angular resolution by way of a respective configuration, and the sensor device (8) has at least one biased magnetic field sensor (9, 10, 11).

2. The angle measurement device (1) as claimed in claim 1, wherein the respective angular resolution is defined by at least one of an angle-dependent distance of the magnetically conductive material from the sensor device (8), an angle-dependent material strength of the magnetically conductive material, or an angle-dependent shape of the magnetically conductive material.

3. The angle measurement device (1) as claimed in claim 1, wherein a separate biased magnetic field sensor (9, 10, 11) is assigned to each of the measurement tracks (4, 5) of the two measurement tracks (4, 5).

4. The angle measurement device (1) as claimed in claim 1, wherein one of the measurement tracks (4) having a higher angular resolution has two sub-tracks with matching angular resolution which are offset with respect to one another in a direction of the rotational movement of the angle disk (2), or two magnetic field sensors (9, 10) which are offset with respect to one another in the direction of the rotational movement of the angle disk (2) are assigned to the measurement track (4) having the higher angular resolution, or both.

5. The angle measurement device (1) as claimed in claim 1, wherein one of the measurement tracks (5) having a lower angular resolution is arranged radially within one of the measurement tracks (4) having a higher angular resolution, or is formed by modulating the measurement track (4) having the higher angular resolution, or both.

6. The angle measurement device (1) as claimed in claim 1, wherein one of the measurement tracks (4, 5) having a lower angular resolution has an angular resolution of more than 180°.

7. The angle measurement device (1) as claimed in claim 4, wherein the angle disk (2) is configured as a gear wheel, and the measurement track (4) having the higher angular resolution is defined by teeth (6) of the gear wheel.

8. The angle measurement device (1) as claimed in claim 6, wherein the measurement track (5) having the lower angular resolution is defined by a delimited material cutout (7) or material thickening (17) in the angle disk (2).

9. The angle measurement device (1) as claimed in claim 1, wherein the magnetic field sensor (9, 10, 11) is a Hall effect sensor, an oscillating sensor, an inductive magnetic field sensor, or an MR sensor.

10. The angle measurement device (1) as claimed in claim 1, wherein the bias is generated by a permanent magnet (12, 13, 14).

11. The angle measurement device (1) as claimed in claim 1, wherein the angle disk (2) is made from a ferromagnetic material.

12. The angle measurement device (1) as claimed in claim 1, wherein one of the measurement tracks (4) having a higher angular resolution is readable with a radially oriented magnetic field sensor (9, 10).

13. An electric motor, comprising a rotor shaft which is mounted in a motor housing, and an angle disk (2) of an angle measurement device (1) as claimed claim 1 is arranged on the rotor shaft.

14. The electric motor as claimed in claim 13, wherein the angle measurement device (1) is arranged in at least one of a winding space or axially between a bearing shield and a motor winding.

15. The angle measurement device as claimed in claim 9, wherein the magnetic field sensor is a TMR sensor, an AMR sensor, or a giant magnetoresistance sensor.

16. The angle measurement device as claimed in claim 1, wherein the angle disk (2) is a cast part.

17. The angle measurement device as claim in claimed 1, wherein one of the measurement tracks (5) having a lower angular resolution is readable with an axially oriented magnetic field sensor (11).
